(19) United States
(12) Patent Application Publication
(10) Pub. No.: US 2026/0221367 A1
(43) Pub. Date: Jul. 30, 2026

(54) SWITCHING DEVICE

(71) Applicant: Ellenberger & Poensgen GmbH, Altdorf (DE)

(72) Inventors: Stefan HOLBE, Nuernberg (DE); Julian KAISER, Erlangen (DE); Hendrik-Christian KOEPF, Nuernberg (DE)

(73) Assignee: Ellenberger & Poensgen GmbH, Altdorf (DE)

(21) Appl. No.: 19/460,939

(22) Filed: Jan. 27, 2026

(30) Foreign Application Priority Data
Jan. 27, 2025 (DE) 10 2025 102 795.1

(51) Int. Cl. H01H 73/04; H01H 1/06; H01H 1/58; H01H 9/44

(52) U.S. Cl. CPC H01H 73/045; H01H 1/06; H01H 1/5805; H01H 9/446

(57) ABSTRACT

A switching device comprising a mechanical switch. The mechanical switch includes a first busbar with a U-shaped section that includes two mutually parallel first legs lying in a shared plane and a second leg perpendicular thereto. One of the first legs has a first fixed contact, and the other first leg has a first power connection. In addition, the mechanical switch includes a second busbar with a first movable contact that is associated with the first fixed contact and is movably supported with respect to same in an opening direction. The plane and the opening direction are tilted with respect to one another.

This nonprovisional application claims priority under 35 U.S.C. § 119(a) to German Patent Application No. 10 2025 102 795.1, which was filed in Germany on January 27, 2025, and which is herein incorporated by reference.

### BACKGROUND OF THE INVENTION

### Field of the Invention

The invention relates to a switching device. The switching device comprises a mechanical switch that includes a first busbar with a first fixed contact, and a second busbar with a first movable contact.

### Description of the Background Art

Circuit breakers are generally used to protect an electrical line or a device in the event of a malfunction of the associated circuit, for example an excessive applied voltage or an excessive flow of electrical current, which occurs, for example, when there is prior damage to the device or electrical line to be protected. In this case, the current flow is interrupted by means of the circuit breaker, thus avoiding further damage.

The circuit breaker has a switch for interrupting the current flow. The circuit breaker thus represents one design of a switching device. For provision of contact protection and ease of installation, the switch is situated inside a housing. The switch is designed as a semiconductor switch, for example. For design reasons the switch has an internal resistance which causes it to heat up during operation, at least when a comparatively high electrical current is conducted. Cooling is therefore necessary, and efficiency is also reduced. Alternatively, the switch has a mechanical design and is in operative connection with a drive which includes an electromagnet, for example. It is thus possible to change the switching state of the switch by energizing the drive.

For conducting the electrical current to be switched, the mechanical switch generally includes multiple busbars, which are usually situated in a respective receptacle in a housing designed as a plastic injection-molded part. The busbars are thus suitably stabilized, with a fixed contact being associated with one of them. A movable contact that is movably supported, in particular by means of the drive, is associated with a different busbar. By operating the drive it is possible to mechanically place the movable contact against the fixed contact or to space them apart from one another.

In the event of a fault such as overcurrent, the mechanical switch must be actuated comparatively quickly so that further damage does not occur. A comparatively powerful drive is therefore typically used, but this increases the installation size and manufacturing costs. In one alternative, the busbar associated with the fixed contact is bent in a U shape, with the fixed contact being associated with one of the parallel legs. The busbar associated with the movable contact is situated in parallel to this leg, with the two busbars being situated essentially in one plane. The busbars are also arranged in such a way that in the electrically conductive state the electrical current flow is antiparallel in the two busbars. When the mechanical switch is opened and an arc forms between the fixed contact and the movable contact, the Lorentz force repels the busbar associated with the movable contact, which speeds up the opening movement. However, due to the U-shaped busbar the installation size of the switching device is increased.

### SUMMARY OF THE INVENTION

It is therefore an object of the invention to provide a particularly suitable switching device, with the installation size and/or manufacturing costs being advantageously reduced, and the switching speed being advantageously increased.

The switching device can be used in particular to switch an electrical current, in particular to create and/or interrupt an electrical current flow. For this purpose the switching device advantageously has two states, namely, an electrically conductive state, which is also referred to as a closed state. In this case it is possible to conduct the electrical current by means of the switching device. For the other state, which is referred to as an open or electrically nonconductive state, in particular flow of electrical current across the switching device is not possible. For example, the switching device is manually actuated/actuatable, so that the switching device is a manual switch. Alternatively or in combination therewith, it is possible, for example, to electrically actuate the switching device, and thus in particular remotely. In another alternative, the switching device is automatically actuated, for example, advantageously as a function of certain conditions. The switching device is suitably a circuit breaker or a contactor.

The circuit breaker can be used, for example, to protect a device, and the circuit breaker is a device circuit breaker, for example. Alternatively or in combination therewith, the circuit breaker is used to protect a line and is thus a line circuit breaker. In particular, the circuit breaker is used in a direct voltage circuit, for example between a load and a direct voltage source or the like, so that in particular a circuit is formed. A direct voltage between 400 V and 650 V, i.e., a particularly high direct voltage, is preferably present in the direct voltage circuit. The circuit breaker for protecting an actuator is preferably used in an industrial facility, with the actuator in particular forming the load. The circuit breaker or at least the switching device is advantageously used in the field of industrial automation. In particular, the voltage switched by means of the circuit breaker is 24 V, 48 V, 380 V, 650 V, 760 V. In one alternative, the circuit breaker is used to protect street lighting, a ship electrical system, infrastructure for railway applications, drives for railway applications, or in the field of electrified aviation. In a further alternative, the circuit breaker/switching device is used in the development and integration of renewable energy generators, in stand-alone electrical grids, for private and domestic use, in greenhouses, in the electrification of road transport vehicles (electromobility), in agriculture, or for construction vehicles. The (direct) voltage used is between 1500 V and 3000 V, for example, or is 110 V, 380 V, 400 V, 800 V, 1000 V, 1500 V, or 3000 V. In summary, as an alternative to use for an industrial facility, the circuit breaker is used, for example, in an electric vehicle, such as a motor vehicle, an aircraft, or a ship/boat.

The switching device can be designed, for example, as an isolating switch, also referred to as an isolator. For example, the switching device includes a mechanical level by means of which the switching state of the switching device may be changed.

The switching device can include in particular two terminals, between which a current path is advantageously formed, and to which further components of the circuit are connected in the installed state. The terminals are suited, in particular provided and configured, for this purpose. A cable or a busbar is advantageously connected to the particular terminal, and has a cross section, for example, between 10 mm2 and 100 mm2 or between 25 mm2 and 92 mm2. The cross section is 16 mm2, 25 mm2, or 35 mm2, for example. The cross section is, for example, 6 mm2, between 6 mm2 and 16 mm2, or between 16 mm2 and 50 mm2. In particular, the terminals are designed in the manner of cage clamps or at least include same.

The switching device can have a mechanical switch. The mechanical switch is advantageously associated with the current path that is possibly present, and in particular is electrically connected between the two terminals of the switching device. It is thus possible to switch the electrical current flow across the switching device by means of the mechanical switch. The mechanical switch is suitably situated in a housing that is preferably made of a plastic. Contact protection for the mechanical switch is thus provided, and the mechanical switch is also protected from environmental influences. Terminals that are possibly present are advantageously introduced into the housing, thus enabling electrical contacting of the possibly present current path or at least of the mechanical switch from outside the housing.

The mechanical switch can have a first busbar and a second busbar. The first busbar includes a first fixed contact, and the second busbar includes a first movable contact. The first movable contact is associated with the first fixed contact. In particular, the second busbar is movably supported, and it is possible to mechanically place the first movable contact against the first fixed contact and also to space them apart from one another. When the first movable contact mechanically rests directly against the first fixed contact, electrical current flow is enabled across the mechanical switch, in particular therefore also across the switching device. On the other hand, if the first movable contact is spaced apart from the first fixed contact, electrical current flow is not possible, and the two possibly present terminals are then advantageously galvanically separated from one another. At least the current path is preferably separated. At a minimum, however, there is no electrical current flow across the mechanical switch.

In summary, the first movable contact can be movably supported with respect to the first fixed contact. The first movable contact is hereby brought into an opening direction, so that the first movable contact is movably supported in the opening direction. For this purpose, the complete second busbar is advantageously movably supported in the opening direction. The opening direction is curved, for example. However, the opening direction is particularly preferably linear, which simplifies the design.

The first busbar can have a U-shaped section. For example, the first busbar is formed by means of the U-shaped section, or the first busbar has even further components. The U-shaped section has two first legs that lie parallel to one another in a shared plane. The U-shaped section also has a second leg that is perpendicular to the two first legs and at the end merges into same, thus forming the U shape. In particular, the first busbar or at least the U-shaped section is designed as one part. The first busbar is suitably made of copper or aluminum. The first busbar is particularly preferably designed as a stamped/bent part, which simplifies manufacture and lowers manufacturing costs. The three legs are thus formed onto one another, which also reduces electrical resistance.

One of the first legs can have the first fixed contact, and the other first leg can have a first power connection. For example, one of the terminals of the switching device is formed by means of the first power connection. Alternatively, the terminals are at least preferably electrically connected to one another, for example via a further busbar and/or a further component, for example a further switch. The end of the first leg opposite from the second leg is suitably formed by means of the first power connection.

The first fixed contact forms, for example, the end of the corresponding first leg opposite from the second leg. At a minimum, however, the first fixed contact is set apart from the second leg, and is preferably situated in the half of the corresponding first leg facing away from the second leg.

The first fixed contact can be fastened to the other components of the first leg, for example, and is advantageously thus electrically contacted with same. For example, the first fixed contact is formed in one piece with the further components of the first leg and/or formed onto same. Alternatively, the first fixed contact is made of some other material than the body of the first leg. It is thus possible to increase burn-off resistance at that location. The first fixed contact is advantageously riveted, soldered, or welded to the body of the first leg. The first busbar, in particular with the exception of the first fixed contact, is advantageously made of copper, preferably nickel-plated copper.

The first movable contact can be formed onto a body of the second busbar or preferably fastened there, and also electrically contacted. For example, this likewise takes place by riveting, soldering, or welding. The bodies of the first and second busbars are suitably made of the same material. The second busbar advantageously has an essentially linear design. This simplifies manufacture and reduces material requirements. The second busbar is suitably a stamped/bent part, which simplifies manufacture.

The plane can be tilted with respect to the opening direction. In other words, an angle different from 0°/180° is formed between the opening direction and the plane. In summary, the opening direction is not situated within the plane, and the plane is not parallel to the opening direction, at least not in the region in which the first movable contact rests against the first fixed contact. As a result, the opening direction is not parallel to the plane.

Consequently, the required installation size of the switching device in the opening direction can be reduced, so that it may have a comparatively compact design. In addition, the distance of the leg associated with the first power connection from the second busbar is decreased; the same is true for portions of the second leg when the second busbar is moved in the opening direction. An interaction of the magnetic field, resulting from a current flow through these legs, with the magnetic field resulting from the current flow through the second busbar and/or the current flow resulting from an arc that is formed between the first fixed contact and the first movable contact is thus increased. In addition, the acting Lorentz force is increased. This causes intensified repulsion of the second busbar from the first leg, which speeds up a switching speed, i.e., a movement of the second busbar in the opening direction. For this purpose it is not necessary for the second busbar to be acted on with excessive force, so that a drive that drives the second busbar may have a compact, inexpensive design. In addition, these magnetic fields contribute to an additional force, or at least an increased force, on the possibly present arc that is formed between the first fixed contact and the first movable contact, so that the first movable contact may be moved away from that location comparatively quickly, in particular into an arc chamber situated in this area. This allows comparatively rapid quenching of the arc that is possibly formed, as a result of which an electrical current flow across the mechanical switch is ended comparatively quickly.

For example, the second busbar can be swivelably supported. However, the second busbar is particularly preferably supported perpendicularly to its longitudinal direction, so that the opening direction runs perpendicularly to the longitudinal direction of the second busbar, thus simplifying the design. For example, the first leg, having the first fixed contact, is securely held, which increases robustness. Alternatively, the first leg is cantilevered, for example, so that in particular possible burn-off of the first fixed contact and/or of the first movable contact may be compensated for. The service life of the switching device is thus increased.

The plane can be substantially perpendicular to the opening direction, at least when the first movable contact rests against the first fixed contact. In other words, an angle of essentially 90° is formed between the opening direction and the plane, with a deviation of 5° of 10°, 5°, or 0°, for example, being present. As a result, the installation size in the opening direction is essentially minimal, and the forces acting on the second busbar/the possibly present arc due to the created magnetic field are maximal, which further increases the switching speed.

For example, the second leg can also be situated in the plane. It is thus possible to form the first busbar, or at least the U-shaped section, by use of a stamped part, thus lowering manufacturing costs. It is also possible to arrange multiple such U-shaped sections one on top of the other, thus simplifying warehousing for the manufacture. However, the second leg is particularly preferably oriented perpendicularly to the plane. If the U-shaped section is designed as a stamped/bent part, the U shape is thus initially stamped out of a metal sheet, and the second leg is subsequently or simultaneously bent by essentially 90° with respect to the first leg. Due to the orientation of the second leg, the U-shaped section is stabilized in all directions, which increases robustness. In summary, manufacture is facilitated and robustness of the switching device is increased.

The mechanical switch suitably includes a third busbar with a second fixed contact, and the second busbar includes a second movable contact. The second movable contact is associated with the second fixed contact. The second movable contact is advantageously likewise movably supported with respect to the second fixed contact in the opening direction. In particular, when the second busbar is moved in the opening direction the second fixed contact is thus moved away from or mechanically placed against the second movable contact, and the first fixed contact is moved away from or mechanically placed against the first movable contact. In particular, the mechanical switch is thus designed in the manner of a double interrupter, thus reducing the voltage that is present between each fixed contact and the associated movable contact in the open switching state of the mechanical switch. Formation of an arc at that location is thus prevented, or this occurs only at a comparatively high applied voltage. An arc chamber is advantageously associated with each fixed contact and the associated movable contact. If only the first fixed contact and the first movable contact are present, the arc chamber is likewise preferably associated with them. In particular, quenching of the respective arc takes place by use of the arc chamber. The arc chamber advantageously includes multiple arc splitters or the like for this purpose.

For example, the third busbar is essentially linear, which simplifies the design and reduces material costs. However, the third busbar particularly preferably also has the U-shaped section with the two mutually parallel first legs and the second leg perpendicular thereto. A second power connection is associated with one of the first legs of the second fixed contact and the other first leg of the third busbar, so that the first legs each have this power connection. The second power connection is suitably electrically connected to the possibly remaining terminal of the switching device, for example directly or via further components. An electrical current flow between the two terminals of the switching device is thus adjusted, in particular enabled or prevented, by means of the mechanical switch.

The third busbar or at least its U-shaped section is particularly preferably structurally identical to the first busbar or its U-shaped section, so that identical parts may be used. Manufacture is thus facilitated and manufacturing costs are reduced. The switching device suitably has an essentially mirror-image or symmetrical design. It is thus in particular possible to insert the switching device between the terminals that are possibly present, in particular bidirectionally, regardless of the particular electrical current flow. Installation of the switching device is thus facilitated, and it is not necessary to pay attention to a certain mounting orientation. Flexibility is also increased.

For example, the two U-shaped sections are lilted with respect to one another. The magnetic force/Lorentz force acting on the second busbar is thus settable fairly precisely and/or corresponding to certain specifications. However, the first legs of the third busbar particularly preferably also lie in the plane, so that all first legs are situated in the plane. Thus, the same force always acts, regardless of the current direction, so that the switching device always has the same behavior regardless of the current direction. The design is also simplified in this way.

The two second legs are particularly preferably situated in parallel to one another. A comparatively compact switching device is thus implemented. Alternatively or particularly preferably in combination therewith, in each case one of the first legs of both U-shaped sections lies on a respective shared straight line. The design is thus simplified, and a short circuit between the individual components is reliably avoided.

For example, the first legs are situated between the second legs of the two U-shaped sections. The second legs of the U-shaped sections are particularly preferably offset relative to one another with respect to the respective first leg. The two second legs thus form the regions of the first and third busbars that are closest to one another. As a result, the interaction of the magnetic field, created due to the electrical current flowing through the second legs, with the second busbar/the possibly present arc is intensified, thus further increasing the switching speed.

The switching device has a circuit board, for example, that suitably includes a body made of a glass fiber-reinforced epoxy resin. In particular, the circuit board includes multiple strip conductors that are fastened to and/or embedded in the body made of glass fiber-reinforced epoxy resin. The strip conductors are advantageously made of copper. The first busbar is advantageously mounted on the circuit board. In other words, the first busbar is not originally a component of the circuit board and therefore is not created by etching, milling, or other abrasive methods, i.e., by material removal of components of the circuit board. Instead, the first busbar is arranged on the circuit board using a joining/connecting process, so that the first busbar in particular is added to the already completed circuit board.

For example, the first busbar is fastened to the circuit board by surface mounting, and the first busbar in particular is designed as an SMD component. The first busbar advantageously has suitable pads for this purpose. In one alternative, the first busbar is mounted on the circuit board by push-through installation, for example. For this purpose, the first busbar advantageously has suitable pins or wire-like extensions that rest in corresponding holes in the circuit board. In particular, for the mounting the first busbar is soldered and/or adhesively bonded to the circuit board. In a further alternative, press-in technology is used for the fastening.

Based on such an embodiment, in particular the electrical current that is conducted via the mechanical switch is not conducted by means of the circuit board, so that it is not necessary to excessively increase the current-carrying capacity of the circuit board. Manufacturing costs are thus reduced. The first busbar is stabilized by means of the circuit board, thus increasing robustness. In addition, it is possible to mount the first busbar on the circuit board in one work step, for example, with the mounting of further components such as electrical and/or electronic components on the circuit board, so that work steps may be saved. In addition, mechanized manufacture is made possible, thus further reducing manufacturing costs.

The plane is preferably perpendicular to the circuit board. Thus, a comparatively large installation space is available on the circuit board for placement of electrical and/or electronic components. The first busbar is advantageously situated on the edge of the circuit board, thus increasing robustness. One of the first legs is suitably mounted on the circuit board, and is preferably situated on the edge thereof. In particular, this is the first leg that is associated with the first power connection. Thus, movement of the second busbar by means of the circuit board is not hindered.

For example, the mechanical switch is only manually actuatable. However, a drive is particularly preferably present which drives the second busbar. It is thus possible to change the switching state of the mechanical switch by operating the drive. For example, it is only possible to change the switching state of the mechanical switch in one direction, for example only from the electrically conductive state to the electrically nonconductive state or vice versa. The design is simplified as a result. However, it is particularly preferably possible by means of the drive to change the switching state of the mechanical switch in both directions, i.e., to bring it into the electrically conductive state and also into the electrically nonconductive state. Functionality is thus increased. For example, the drive has a mechanical design. However, the drive particularly preferably has an electrical design. For example, the combination of the mechanical switch and the drive forms a relay. The drive advantageously includes an electrical coil.

During operation of the drive a magnetic component, for example a permanent magnet or a ferromagnetic component, is suitably moved within the coil.

The drive is designed as a moving magnet actuator, for example. The magnetic component, which is movably supported, is also associated with the moving magnet actuator. In addition, the moving magnet actuator includes a first drive unit together with one or more electrical coils that are energized when the drive is actuated, so that a magnetic interaction occurs between them and the magnetic component. The electrical coils are stationarily mounted. Since the electrical coil(s) is/are stationarily mounted, the design is simplified, and with the exception of the components needed for the support, no further moving parts or electrical connections between the moving parts, namely, the component and the stationary components of the moving magnet actuator (also referred to below merely as an actuator), are required. Friction is also reduced as a result.

The drive unit preferably can include two electrical coils which are structurally identical, for example. However, the two electrical coils are at least offset relative to one another along a longitudinal axis and situated concentrically with respect to same. The (magnetic) component is situated in particular on the longitudinal axis, and is supported so that it is movable along same. For one switching state of the mechanical switch, the component is situated in an air gap that is present between the two electrical coils, and is held at that location by means of a magnetic short-circuit plate, for example. In contrast, in the other switching state the component is offset along the longitudinal axis.

Since the number of moving parts of the moving magnet actuator, in particular just the component, are/is comparatively small and in particular have/has a comparatively low weight, the dynamics of the actuator are comparatively high. Inertia during actuation of the mechanical switch is thus reduced. Comparatively fast switching is thus enabled by use of the switching device.

The second busbar can be supported via the drive. The number of required components is thus reduced. For example, the drive is separate from the circuit board that is possibly present, thus enabling a flexible design. It is also possible for the switching device to have a modular design, thus enhancing versatility. However, the drive is particularly preferably connected to the circuit board that is possibly present. The drive is thus also stabilized by means of the circuit board, which increases robustness. In this way, the second busbar is also aligned with respect to the first busbar in a comparatively precise manner, thus improving the switching behavior of the mechanical switch. In this case the drive advantageously has an electrical design, and the individual components of the drive, or at least one of them, are/is connected to one another by means of the circuit board. The number of required components and the manufacturing costs are thus further reduced.

The switching device can include a control unit via which the drive is operated. The control unit is advantageously provided via the circuit board that is possibly present. In other words, the circuit board includes multiple electrical and/or electronic components that are connected to one another via some of the strip conductors of the circuit board. Interconnection by means of which in particular the control unit is formed is thus provided. As a result, the control unit is also stabilized with respect to the drive, thus further increasing robustness. It is also possible, for example, to mount the individual components of the control unit and/or of the drive and the first busbar on the circuit board in one work step, thus further shortening the manufacturing time.

The switching device advantageously includes multiple sensors that are read out by means of the control unit, for example. The sensors are advantageously likewise fastened to the circuit board that is possibly present, and with some of the strip conductors of the circuit board are electrically connected to the control unit, and thus connected via signal. Manufacturing is thus further facilitated and robustness is further increased. At least one of the sensors is preferably associated with the first busbar and/or the possibly present third busbar. In particular, a voltage present between same and/or a respective electrical current conducted via same is thus detectable. On this basis the drive is preferably operated by means of the control unit, and the switching device in this case is preferably designed as a circuit breaker.

For example, the switching device has a solely mechanical design. Alternatively, the switching device also includes a semiconductor switch which is a field-effect transistor, for example. In particular, the semiconductor switch is a power semiconductor switch such as a MOSFET, JFET, GTO, or IGBT. For example, the semiconductor switch is spaced apart from the possibly present circuit board. The semiconductor switch is particularly preferably mounted on the circuit board or on some other circuit board, and is thus electrically contacted thereto and fastened there. In addition, mechanized manufacture, at least in part, of the switching device is made possible. Furthermore, it is possible to mount the semiconductor switch on the circuit board in one work step together with mounting of, for example, the possibly present control unit or the first busbar. The semiconductor switch is preferably fastened to the circuit board by means of surface mounting. As a result, the semiconductor switch is stabilized and the number of required components is reduced. In particular, the circuit board includes a driver circuit, or the driver circuit is at least mounted on the circuit board or suitably provided by same. Operation of the semiconductor switch by means of the circuit board is thus made possible, which further reduces the number of required components.

For example, the semiconductor switch is electrically connected in parallel to the mechanical switch. The semiconductor switch is particularly preferably placed in the electrically conductive state before the mechanical switch is opened. When the first movable contact is spaced apart from the first fixed contact, the electrical current thus commutates over to the semiconductor switch, so that, for example, no arc is formed between the first movable contact and the first fixed contact. When these are spaced far enough apart, the semiconductor switch is advantageously brought into the electrically nonconductive state. The electrical current flow across the switching device is thus prevented. Due to the mechanical switch, only small electrical resistances are present during normal operation, in particular compared to use of only the semiconductor switch, thus improving efficiency.

The semiconductor switch can be advantageously electrically connected in series with the mechanical switch. It is thus possible, for example, to initially interrupt the electrical current across the switching device by means of the semiconductor switch, and subsequently to place the mechanical switch in the open state. Here as well, there is no formation of an arc, although the possibly present terminals are galvanically separated from one another due to the mechanical switch.

The switching device can be particularly preferably used for interrupting direct voltage and/or direct current. The switching device is advantageously used in a motor vehicle or in an industrial facility. The invention further relates to the corresponding use of the switching device, which preferably is an integral part of a circuit breaker. Moreover, the invention relates to a circuit that includes such a switching device. The circuit advantageously includes a direct voltage source and a load. In particular, the circuit is an integral part of a motor vehicle. The direct voltage source is an energy store, for example, such as a high-voltage battery, and the load is an electric motor, for example, or at least a drive that includes the electric motor.

The switching device can be advantageously designed as a circuit breaker. The mechanical switch is suitably operated as a function of a trigger characteristic curve. The mechanical switch is preferably opened by means of the drive when an electrical current has been conducted for a certain period of time that is specified by the trigger characteristic curve. The control unit and/or a sensor for detecting the electrical current conducted by means of the switching device are/is advantageously present. The sensor preferably includes a shunt. The invention further relates to such a circuit breaker.

The refinements and advantages explained in conjunction with the switching device are analogously transferable to the use/the circuit/the circuit breaker and among one another, and vice versa.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 schematically shows a direct voltage circuit with a load and a circuit breaker,

FIG. 2 shows a perspective view of the circuit breaker, which includes a housing with housing halves,

FIG. 3 shows a perspective view of the circuit breaker with one of the housing halves removed so that a mechanical switch having a first, second, and third busbar is visible, and

FIG. 4 shows an enlarged view of the mechanical switch.

### DETAILED DESCRIPTION

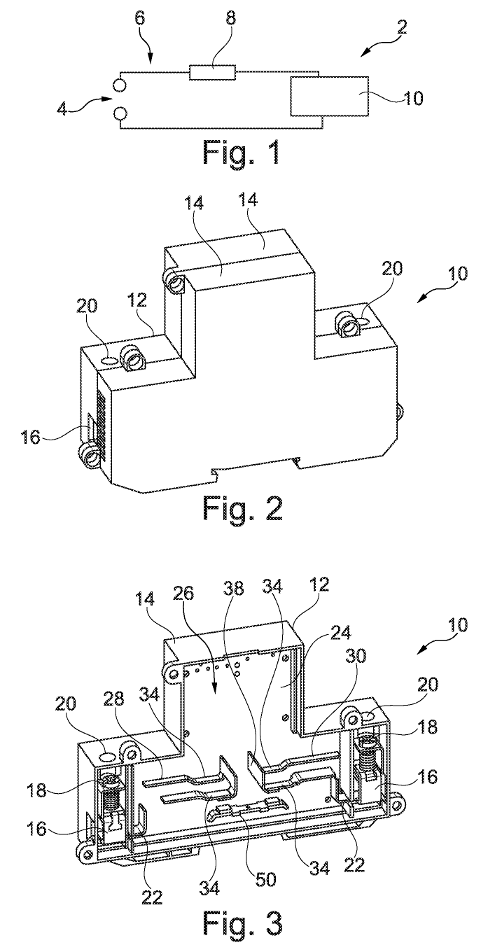

A direct voltage circuit 2 that includes a direct voltage source 4 is illustrated in FIG. 1 in a schematically simplified manner. A direct voltage of 650 V is provided by means of the direct voltage source, and feeds a direct voltage DC link 6. A load 8 that is electrically connected to the direct voltage DC link 6 via a switching device 10 is supplied with power by the direct voltage DC link.

FIG. 2 shows a perspective view of the device 10, which is designed as a circuit breaker. The switching device 10 includes a housing 12 with two housing halves 14, made of plastic, that are joined together. FIG. 3 illustrates a perspective view of the switching device 10 with one of the two housing halves 14 removed. Two openings within which a terminal 16 is situated in each case are introduced into the housing 12. Connection of a line of the direct voltage DC link 6 or an electrical line associated with the load 8 is made possible at that location. The terminals 16 each have a clamping screw 18 that is accessible through a mounting opening 20 in the housing 12. The line associated with the respective terminal 16 is clamped and thus electrically contacted by screwing in the clamping screws 18.

Each of the terminals 16 is electrically contacted with a respective further busbar 22 that is made from a tin-plated copper strip and bent into an L shape. The further busbars 22 rest partially against the edge of a circuit board 24 and are mounted thereon. The further busbars 22 are thus stabilized by means of the circuit board 24, and are also electrically contacted with the circuit board 24.

Electrically connected between the two busbars 22 is a mechanical switch 26 having a first busbar 28 and a third busbar 30, each of which is mounted on the circuit board 24. The further busbars 22 are respectively electrically contacted with the first busbar 28 or with the third busbar 30 by means of the strip conductors, not illustrated in greater detail, of the circuit board 24. The first busbar 28 and the third busbar 30 are mechanically separate from one another, and therefore are also not directly electrically connected to one another. In addition, the first and third busbars 28, 30 are not electrically connected by means of the strip conductors of the circuit board 24.

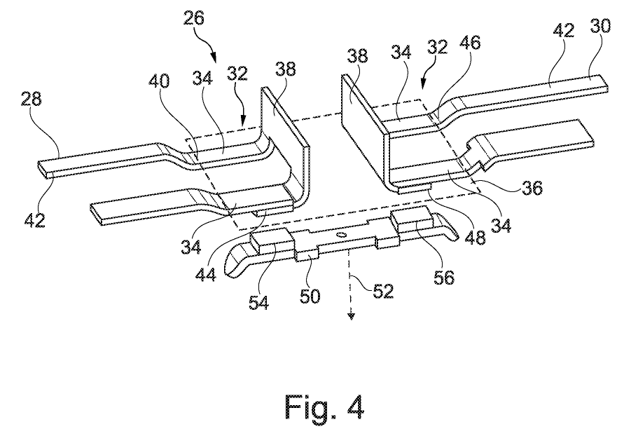

The mechanical switch 26 is illustrated in enlarged scale in FIG. 4. The first and third busbars 28, 30 have a mirror-image design, and in each case have a U-shaped section 32 that includes two mutually parallel first legs 34.

Each of the first legs 34 of the first busbar 28 and each of the first legs 34 of the third busbar 30 lie on a shared straight line, and all first legs 34 lie in a plane 36 that is perpendicular to the circuit board 24. In each case a second leg 38 of each U-shaped section 32 is perpendicular to the plane 36 and to the first legs 34, and is connected to the ends of the respective first leg 34. The two U-shaped sections 32 are oriented in such a way that the two second legs 38 are situated in parallel to one another and offset relative to one another with respect to the respective first leg 34. In other words, the second legs 38 form the part that is closest to the respective other busbar 28, 30.

One of the first legs 34 of the first busbar 28 rests against the edge of the circuit board 24, and at the end opposite from the second leg 38 has a first power connection 40 onto which an extension 42 of the first busbar 28 is formed. This extension is essentially parallel to the plane 36 but offset vertically relative to same, and is likewise mounted on the circuit board 24. The extension 42 is electrically connected to the associated further busbars 22 by means of the strip conductors, not illustrated in greater detail. The other first leg 34 of the first busbar 28 has a first fixed contact 44. With the exception of the first fixed contact 44, the first busbar 28 is a one-piece stamped/bent part made of tin-plated copper.

Since the third busbar 30 has a mirror-image design, it likewise has the extension 42, which is formed onto a second power connection 46, corresponding to the first power connection 40, of one of the first legs 34 of the third busbar 30. Instead of the first fixed contact 44, the third busbar 30 has a second fixed contact 48. The second fixed contact 48 and the first fixed contact 44 are situated on the same side of the plane 36.

The mechanical switch 26 also has a second busbar 50 situated in parallel to the plane 36. By means of a drive, not illustrated in greater detail, that is fastened to the circuit board 24, the second busbar 50 is movably supported in an opening direction 52 perpendicular to the plane 36. As a result, the plane 36 and the opening direction 52 are tilted with respect to one another.

The second busbar 50 has a first movable contact 54 and a second movable contact 56 that are fastened to, and thus electrically contacted with, the other components of the second busbar 50, which are likewise designed in one piece as a stamped/bent part made of tin-plated copper. The two movable contacts 54, 56 are situated on the side facing the plane 36. Due to the movable support of the second busbar 50, in the opening direction 52 the two movable contacts 54, 56 are also movably supported with respect to the plane 36 and thus also with respect to the two fixed contacts 44, 48. The first movable contact 54 is associated with the fixed contact 44, and the second movable contact 56 is associated with the second fixed contact 48, so that upon a corresponding movement of the second busbar 50 they may be brought into direct contact or spaced apart from one another. If there is direct mechanical contact, the mechanical switch 26 is closed, and an electrical current flow between the terminals 16 is possible. On the other hand, if the mechanical contact is discontinued, no electrical current flow is possible and the mechanical switch 26 is open.

If a sensor, not illustrated in greater detail, identifies a malfunction of the load 8 or some other components of the direct voltage circuit 2, the second busbar 50 is moved away from the first and third busbars 28, 30 by means of the drive; i.e., the switch is opened. For example, a current sensor that measures electrical current flowing across one of the busbars 22, 28, 30, 50 and that in particular is connected to the circuit board 24 is used as a sensor. The switching device 10 advantageously includes a control unit by means of which the sensor is read out and the drive is energized. The control unit is preferably formed, at least in part, by the circuit board 24.

When the mechanical switch 26 is opened, it is possible for an arc to form in each case in the second movable contact 56, between the first fixed contact 44 and the first movable contact 54, and between the first fixed contact 44 and the second fixed contact 48, so that electrical current continues to flow across the mechanical switch 26. A magnetic field is thus formed around the first legs 34 and the second legs 38 due to the electrical current that continues to flow through the U-shaped sections 32. This magnetic field interacts with the magnetic field that forms around the second busbar 50 due to the current flow through same, which results in repulsion of the second busbar 50 from the first and third busbars 28, 30. The second busbar 50 is thus additionally accelerated. The arcs are thus lengthened comparatively quickly, which increases the voltage necessary for maintaining. It is thus possible for the arcs to have already collapsed, and for the current flow across the electrical switch 26 to halt. In addition, due to the magnetic fields that are formed around the U-shaped sections 32, a Lorentz force acts on the arcs extending perpendicularly to the plane 36, so that the arcs are driven into an arc chamber, not illustrated in greater detail, which further increases the voltage necessary for maintaining.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A switching device comprising:
a mechanical switch that includes a first busbar with a U-shaped section that includes two mutually parallel first legs lying in a shared plane and a second leg arranged substantially perpendicular thereto, wherein one of the first legs has a first fixed contact, and the other first leg has a first power connection; and
a second busbar with a first movable contact that is associated with the first fixed contact and is movably supported with respect to the same in an opening direction,
wherein the shared plane and the opening direction are tilted with respect to one another.

2. The switching device according to claim 1, wherein the plane is substantially perpendicular to the opening direction.

3. The switching device according to claim 1, wherein the second leg is oriented substantially perpendicularly to the plane.

4. The switching device according to claim 1, wherein the mechanical switch has a third busbar with a second fixed contact, and wherein the second busbar includes a second movable contact that is associated with the second fixed contact.

5. The switching device according to claim 4, wherein the third busbar includes a U-shaped section with the two mutually parallel first legs lying in the plane and the second leg perpendicular thereto, and wherein one of the first legs has the second fixed contact, and the other first leg has a second power connection.

6. The switching device according to claim 5, wherein the second legs of the two U-shaped sections are offset relative to one another with respect to the respective first leg.

7. The switching device according to claim 1, wherein the first busbar is mounted on a circuit board that is substantially perpendicular to the plane.
